(19) United States
(12) Patent Application Publication
(10) Pub. No.: US 2024/0377588 A1
(43) Pub. Date: Nov. 14, 2024

(54) FIBER ARRAY UNIT FORMATION

(71) Applicant: CORNING RESEARCH & DEVELOPMENT CORPORATION, Corning, NY (US)

(72) Inventors: Joel Patrick Carberry, Big Flats, NY (US); Leonard Charles Dabich, II, Painted Post, NY (US); Stephan Lvovich Logunov, Corning, NY (US); Mark Alejandro Quesada, Horseheads, NY (US); Alexander Mikhailovich Streltsov, Corning, NY (US)

(21) Appl. No.: 18/779,842

(22) Filed: Jul. 22, 2024

Related U.S. Application Data
(63) Continuation of application No. PCT/US2023/010374, filed on Jan. 9, 2023.
(60) Provisional application No. 63/302,157, filed on Jan. 24, 2022.

(51) Int. Cl. G02B 6/255; C03C 25/6208

(52) U.S. Cl. CPC G02B 6/2552; C03C 25/6208

(57) ABSTRACT

Methods and systems for forming a fiber assembly are provided herein. A method comprises removing an excess portion from an end of an optical fiber to form a severed end. The optical fiber defines an optical variation portion that includes an optical pathway defining a varying output characteristic of optical signals depending on a position therealong. When the severed end is formed, the position of the severed end along the optical variation portion defines the output characteristic of optical signals therefrom. The method further includes positioning the optical fiber with the severed end onto a film disposed on a surface of a substrate and placing a fixture thereover. The method further includes applying heat to the film through an opening of the fixture to create a bond between the optical fiber and the surface of the substrate.

### CROSS-REFERENCE TO RELATED APPLICATION

This application is a continuation of International Patent Application No. PCT/US2023/010374 filed Jan. 9, 2023, which claims priority to U.S. Patent Application No. 63/302,157, filed Jan. 24, 2022, which is incorporated herein by reference in its entirety.

### FIELD

Embodiments of the present disclosure relate generally forming fiber array units, and more particularly to forming fiber array units with customized optical focusing characteristics.

### BACKGROUND

Benefits of optical communication include extremely wide bandwidth and low noise operation. Because of these advantages, optical fiber is increasingly being used for a variety of applications, including, but not limited to, broadband voice, video, and data transmission. Connectors are often used in data center and telecommunication systems to provide service connections to rack-mounted equipment and to provide inter-rack connections. Accordingly, optical connectors are employed in both optical cable assemblies and electronic devices to provide an optical-to-optical connection wherein optical signals are passed between an optical cable assembly and an electronic device.

Optical devices, such as optical connectors, may include optical elements secured to a substrate. For example, an optical connector may include optical fibers secured to a substrate by use of an adhesive, which may have a high coefficient of thermal expansion (CTE). The optical connectors may then be connected to another optical device to provide optical communication between optical devices. In one example, the optical connector is connected to an edge of a waveguide substrate having waveguides providing optical channels. The waveguide substrate may be a component of a photonic integrated circuit assembly, for example. In some cases, the connected optical connector and the optical device may be subjected to elevated temperatures, such as during a solder reflow process. The high CTE adhesive may cause the position of the optical elements to shift due to the elevated temperatures and become misaligned with the optical channels of the optical device. The shifting of the optical elements may prevent optical signals from passing between the optical connector and the optical device.

### BRIEF SUMMARY

Embodiments of the present disclosure are directed to methods for forming a fiber array unit (FAU) by bonding one or more optical elements, such as optical fibers, gradient-index (GRIN) lenses, micro-lenses, waveguides, optical filters, and the like, to a substrate using a laser beam, as well as optical connectors and assemblies resulting from said methods. Some embodiments of the present disclosure are directed to fusion splicing equivalently dimensioned fibers, in parallel, followed by a polish back or cleaving, which affords a pitch tolerance configured for fiber-to-fiber bonding, while providing focusing, or collimating functions promoting device coupling.

In this regard, some embodiments of the present disclosure are directed to providing control over the output angle (e.g., collimating, focusing) of an FAU. The controlled output angle affords ability to collect or guide propagating photonic information in communication devices, such as, fibers, waveguides, wavelength multiplexers/demultiplexers, multicore fan-out devices, and other devices-enabling customized FAUs that produce the most desirable output signal characteristics.

Some embodiments of the present disclosure are directed to precision laser cleaved, and laser welded optical fibers to form an FAU in an automated process. The formation may be scalable such as to meet the demand for FAU's in the 5G era and beyond.

In some embodiments, a method of forming a fiber array unit is provided. The method comprises removing an excess portion from an end of an uncut optical fiber to form an optical fiber defining a severed end defining an output characteristic of optical signals therefrom. The uncut optical fiber may define an optical variation portion leading to the end. The optical variation portion may include an optical pathway defining a varying output characteristic of optical signals depending on a position along the optical variation portion such that, when the severed end is formed, the position of the severed end along the optical variation portion defines the output characteristic of optical signals therefrom. The method may continue by positioning a portion of the optical fiber with the severed end on to a film disposed on a surface of a substrate. The method may continue by placing a fixture over the optical fiber such that a bottom surface of the fixture is in contact with the surface of the substrate. The fixture may define an opening over the portion of the optical fiber. The method may continue by applying heat to the film under the portion of the optical fiber through the opening of the fixture to create a bond between the portion of the optical fiber and the surface of the substrate. After forming the bond, the method may continue by removing the fixture from the surface of the substrate.

In some embodiments, the optical fiber may be a multi-mode fiber. In some embodiments, the removing the excess portion comprises perforating the uncut optical fiber. The perforations may be positioned along the uncut optical fiber to enable severing of the optical fiber at the perforations so as to define the excess portion of the uncut optical fiber. The method may continue by applying a force to the excess portion thereby removing the excess portion of the uncut optical fiber at one of the perforations thereby forming the severed end of the optical fiber.

In some embodiments, the perforations may be formed with a femtosecond laser.

In some embodiments, the force applied to remove the excess portion is applied with compressed air.

In some embodiments, the uncut optical fiber may be formed of a first optical fiber spliced to a second optical fiber at a splice point. The second optical fiber may define the optical variation portion of the optical fiber.

In some embodiments, the bond between the optical fiber and the surface of the substrate may be between the first optical fiber and the surface of the substrate.

In some embodiments, the second optical fiber may be a multimode fiber.

In some embodiments, the second optical fiber may define a gradient index (GRIN) lens.

In some embodiments, the method further comprises doping the optical variation portion of the uncut optical fiber with a halide. The method may continue by heating the severed end of the optical fiber to form a taper. The taper may define a slope, which may define the output characteristic of optical signals of the optical fiber at the severed end.

In some embodiments, the halide may be one of chlorine, fluorine, or germanium.

In some embodiments, the output characteristic of optical signals may be one of collimating, diverging, or focusing.

In some embodiments, the one optical fiber is one of a plurality of optical fibers. The plurality of optical fibers may define a fractional pitch between 0.45 and 0.55.

In some embodiments, the fractional pitch may be configured for light-capture applications, wherein the light-capture applications require large acceptance angles.

In some embodiments, the optical fiber may be one of a plurality of optical fibers, wherein when bonded to the surface of the substrate, the plurality of optical fibers may define a pitch error of less than 0.7 um.

In some embodiments, the method further comprises coupling the severed end of the fiber array unit with a second severed end of a second fiber array unit to form an interface for data transfer between the fiber array unit and the second fiber array unit.

In another example embodiment a system for forming a fiber array unit is provided. The system comprising a device configured to secure an uncut optical fiber. The uncut optical fiber may define an optical variation portion leading to an end. The optical variation portion may include an optical pathway defining a varying output characteristic of optical signals depending on a position along the optical variation portion such that, when a severed end is formed by removal of an excess portion of the uncut optical fiber, the position of the severed end along the optical variation portion defines an output characteristic of optical signals therefrom. The system may further include a first laser configured to perforate the uncut optical fiber to define the excess portion. The system may further comprise a gas source for providing gas, and at least one nozzle connected to the gas source, wherein the at least one nozzle is aimed towards the excess portion. A force of the gas expelled from the at least one nozzle is configured to remove the excess portion to form an optical fiber with the severed end. The system may further include a positioning substrate configured to align the optical fiber onto a surface of a substrate. The system may further include a fixture configured to align the optical fiber on the surface of the substrate such that the severed end is aligned with an end face of the substrate. The fixture may define an opening over the optical fiber. The system may further comprise a second laser configured to apply heat to a film disposed between the optical fiber and the surface of the substrate through the opening so as to create a bond between the optical fiber and the surface of the second substrate.

In some embodiments, the first laser may be a femtosecond laser. In some embodiments, the gas supplied by the gas source may be compressed air.

In some embodiments, the system further comprises a halide source for providing a halide, and a dispenser for doping the optical variation portion of the at least one optical fiber with the halide, thereby creating a taper of an inner portion of the optical pathway.

In some embodiments, the uncut optical fiber is a multi-mode fiber. In some embodiments, the uncut optical fiber includes a gradient index (GRIN) lens.

In yet another example embodiment a process for forming a fiber array unit is provided. The process comprises removing an excess portion from an end of an uncut optical fiber to form an optical fiber defining a severed end. The severed end may define an output characteristic of optical signals therefrom. The uncut optical fiber may define an optical variation portion leading to the end. The optical variation portion may include an optical pathway defining a varying output characteristic of optical signals depending on a position along the optical variation portion such that, when the severed end is formed, the position of the severed end along the optical variation portion defines the output characteristic of optical signals therefrom. The process may further comprise positioning a portion of the optical fiber with the severed end on to a film disposed on a surface of a substrate. The process may further comprise placing a fixture over the optical fiber such that a bottom surface of the fixture is in contact with the surface of the substrate. The fixture may define an opening over the portion of the optical fiber. The process may further comprise applying heat to the film under the portion of the optical fiber through the opening of the fixture to create a bond between the portion of the optical fiber and the surface of the substrate. The process my further include removing the fixture from the surface of the substrate.

In yet another example embodiment, a method of forming a fiber array unit is provided. The method comprises removing an excess portion from an end of an uncut optical fiber to form an optical fiber defining a severed end defining an output characteristic of optical signals therefrom. The uncut optical fiber may define an optical variation portion leading to the end. The optical variation portion may include an optical pathway defining a varying output characteristic of optical signals depending on a position along the optical variation portion such that, when the severed end is formed, the position of the severed end along the optical variation portion defines the output characteristic of optical signals therefrom. The method may continue by positioning a portion of the optical fiber with the severed end on to a film disposed on a surface of a substrate. The method may continue by placing a fixture over the optical fiber such that a bottom surface of the fixture is in contact with the surface of the substrate. Pressure may be applied to the substrate to maintain contact between the substrate and the optical fiber. The method may continue by applying heat to the film under the portion of the optical fiber through a bottom surface of the substrate to create a bond between the portion of the optical fiber and the surface of the substrate. After the optical fiber is bonded to the substrate the fixture and the pressure may be removed from the substrate.

### BRIEF DESCRIPTION OF THE SEVERAL VIEWS OF THE DRAWING(S)

Having thus described embodiments of the disclosure in general terms, reference will now be made to the accompanying drawings, which are not necessarily drawn to scale, and wherein:

FIG. 1 illustrates a perspective view of an example fiber array unit, in accordance with some embodiments discussed herein;

FIGS. 2A-E illustrate perspective views of forming an example fiber array, in accordance with some embodiments discussed herein;

FIG. 3 illustrates a perspective view of an example fixture, in accordance with some embodiments discussed herein;

FIGS. 4A-E illustrate perspective views of forming the example fiber array shown in FIG. 1, in accordance with some embodiments discussed herein;

FIG. 5 illustrates a cross-sectional view of an example spliced optical fiber, in accordance with some embodiments discussed herein;

FIGS. 6A-C illustrate perspective views of example optical fibers defining varying output characteristics, in accordance with some embodiments discussed herein;

FIG. 7A illustrates a top view of an example uncut fiber array, in accordance with some embodiments discussed herein;

FIG. 7B illustrates a top view of an example optical fiber polished back from the example uncut fiber array shown in FIG. 7A, in accordance with some embodiments discussed herein;

FIG. 8A illustrates a perspective view of an example optical fiber with a tapered core, in accordance with some embodiments discussed herein;

FIG. 8B illustrates a close up view of the tapered core shown in FIG. 8A, in accordance with some embodiments discussed herein;

FIG. 9A illustrates an example 2D fiber array connector for use with the example fiber array unit shown in FIG. 1, in accordance with some embodiments discussed herein;

FIG. 9B illustrates a cross-sectional view of an example assembly for use with the example fiber array unit shown in FIG. 1, in accordance with some embodiments discussed herein;

FIG. 9C illustrates a cross-sectional view of an example assembly for use with the example fiber array unit shown in FIG. 1, in accordance with some embodiments discussed herein;

FIG. 9D illustrates a cross-sectional view of an example application for use with the example fiber array unit shown in FIG. 1, in accordance with some embodiments discussed herein;

FIG. 10A illustrates a photograph of an example optical fiber in accordance with some embodiments discussed herein;

FIG. 10B illustrates an example chart of image distance verse fractional pitch, of the optical fiber of FIG. 10A, in accordance with some embodiments discussed herein;

FIG. 10C illustrates an example chart of magnification verse fractional pitch, of the optical fiber of FIG. 10A, in accordance with some embodiments discussed herein;

FIG. 10D illustrates an example chart of divergence/acceptance angle verse fractional pitch, of the optical fiber of FIG. 10A, in accordance with some embodiments discussed herein;

FIG. 11A illustrates an example schematic of a system utilizing an example optical fiber for use in a fiber array unit, in accordance with some embodiments discussed herein;

FIG. 11B illustrates an example chart of intensity output from the example optical fiber shown in FIG. 11A, in accordance with some embodiments discussed herein;

FIG. 11C illustrates an example chart of intensity output from the example optical fiber shown in FIG. 11A, in accordance with some embodiments discussed herein;

FIG. 12A illustrates an example chart characterization of the far field intensity distribution for an example optical fiber, in accordance with some embodiments discussed herein;

FIG. 12B illustrates an example chart illustrating coupling losses due to tilt angles, in accordance with some embodiments discussed herein;

FIG. 13 illustrates a perspective view of an example connector for use with a 2D fiber array unit, in accordance with some embodiments discussed herein;

FIGS. 14A-14E illustrate example photographs of formation of an example fiber array unit, in accordance with some embodiments discussed herein;

FIGS. 15A-B illustrate photographs of an example optical fiber, in accordance with some embodiments discussed herein;

FIGS. 15C-D illustrate example charts of pitch error within fiber array units, in accordance with some embodiments discussed herein;

FIG. 16 illustrates a flowchart of an example method for forming an example fiber array unit, in accordance with some embodiments discussed herein; and

FIG. 17 illustrates a flowchart of an example method for forming an example fiber array unit, in accordance with some embodiments discussed herein.

### DETAILED DESCRIPTION

Some example embodiments will now be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Embodiments of the present disclosure provide for a fiber array unit (FAU), and methods of making an FAU with customized output characteristics of output signals.

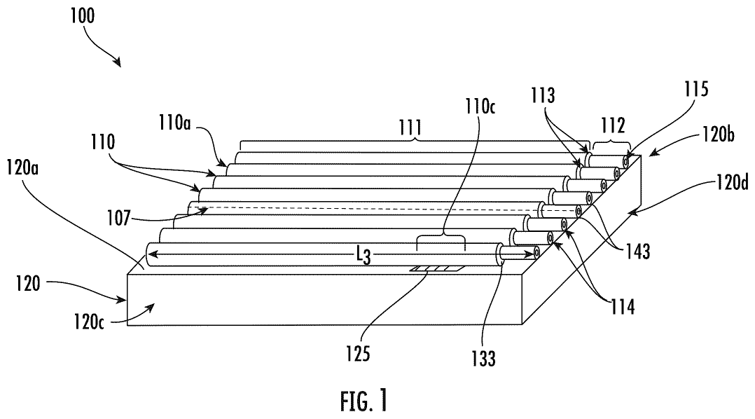

As discussed above optical fibers may be manipulated to provide output angles to collect, guide or disperse propagating photonic information in communication devices. FIG. 1 illustrates an example FAU 100, having an optical fiber 110 disposed on a film 125 positioned on a surface 120a of a substrate 120. The optical fiber 110 may be laser welded to the surface 120a of the substrate 120 by directing heat towards the film 125. Notably, the optical fiber 110 may be laser welded to the substrate with methods as disclosed within U.S. Pat. No. 10,345,533, entitled “Assemblies, Optical Connectors and Methods of Bonding Optical Fibers to Substrates”, filed Feb. 15, 2018; U.S. Pat. No. 10,422,961, entitled “Fiber Array Formed Using Laser Bonded Optical Fibers”, filed February Oct. 11, 2018; U.S. Pat. No. 10,545,293, entitled “Assemblies, Optical Connectors and Methods of Bonding Optical Fibers to Substrates”, filed May 13, 2019; and U.S. Pat. No. 10,746,937, entitled “Assemblies, Optical Connectors and Methods of Bonding Optical Elements to Substrates”, filed Oct. 25, 2019, which are assigned to the Assignee and Applicant of this application, and which are each incorporated by reference herein in their entireties.

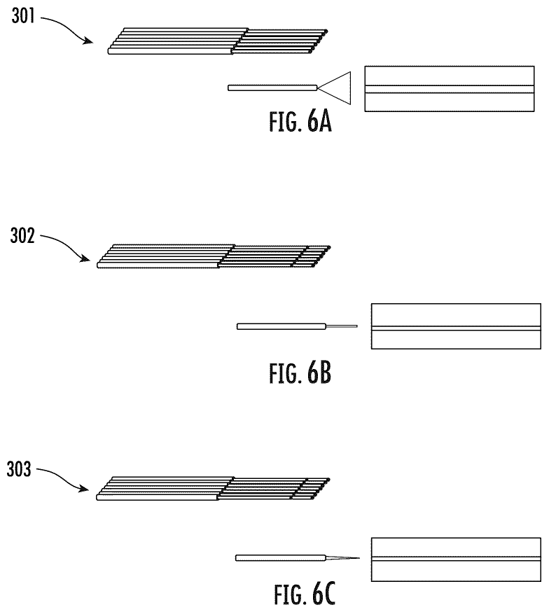

In some embodiments, the optical fiber 110, may define a length L₃ extending between a first end 110a and a severed end 115. An optical pathway 107 may extend along the length L₃ of the optical fiber 110. In some embodiments, the optical pathway 107 is configured such that the length L₃ of the optical fiber 110 defines an output characteristic of optical signals extending from the severed end 115 of optical fiber 110, and thereby the optical pathway 107. In some embodiments, the optical pathway 107 may extend through a core 114 of the optical fiber 110. The core 114 may be surrounded by cladding which may define refractive characteristics of the optical fiber 110. In some embodiments, the length L₃ of the at least one optical fiber 110 may determine output characteristics of the optical fiber 110. In this regard, a portion of the optical fiber 110 may define an optical variation portion where the output characteristics of output signals vary depending on the position along the optical variation portion. By positioning the severed end 115 at different positions along the optical variation portion, different output characteristics may be obtained (e.g., choosing where to position the severed end 115 allows for customized output characteristics). The output characteristics may be, for example, focusing, collimating, and/or diverging characteristics of a ray and/or beam (see e.g., FIG. 6) propagating within the optical fiber 110.

In some embodiments, the severed end 115 of the optical fiber 110 is aligned with an end face 120d of the substrate 120. The severed end 115 and may be coupled with a ferrule or other optical coupling device to transfer and transmit data and optical information between the optical fiber 110 and another device.

In some embodiments, as illustrated in FIG. 1, the optical fiber 110 may be formed from a first optical fiber 111 and a second optical fiber 112 spliced together at a splice point 113. In some embodiments, the film 125 is disposed under a portion 110c the first optical fiber 111, and the severed end 115 is on the second optical fiber 112. In some embodiments, the portion 110c of the optical fiber may extend across the surface 120a of the substrate 120, while in other embodiments, the portion 110c may extend partially across the surface 120a of the substrate 120.

In some embodiments, the optical fiber 110 is an 8 optical fiber ribbon positioned on the surface 120a of the substrate 120, wherein the optical fibers 110 extend from a first side 120c of the substrate 120 to a second side 120b of the substrate 120. In some embodiments, optical fiber 110 may extend between the first side 120c to the second side 120b of the substrate 120, while in other embodiments, the optical fiber 110 may extend partially between the first side 120c and the second side 120b.

In some embodiments, the first optical fiber 111 is a single mode fiber (SMF). The single mode fiber may allow a single ray to propagate within the core. In some embodiments, the second optical fiber 112 is a multimode fiber (MMF). More specifically, in some embodiments, the second optical fiber 112 is configured as a gradient index (GRIN) lens. The GRIN-MMF may allow for multiple rays to propagate within the core, and may allow the rays, and/or the data carried by the rays to travel faster. In some embodiments, the second optical fiber 112 may have a parabolic gradient-index profile. In some embodiments, the second optical fiber 112 may have a core 142. The core 142 may be a 50 μm, or a 62.5 μm diameter. In some embodiments, the gradient-index profile may be an α=2 profile.

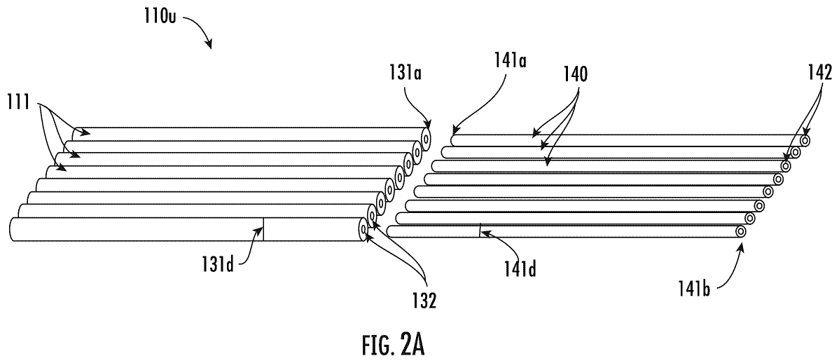

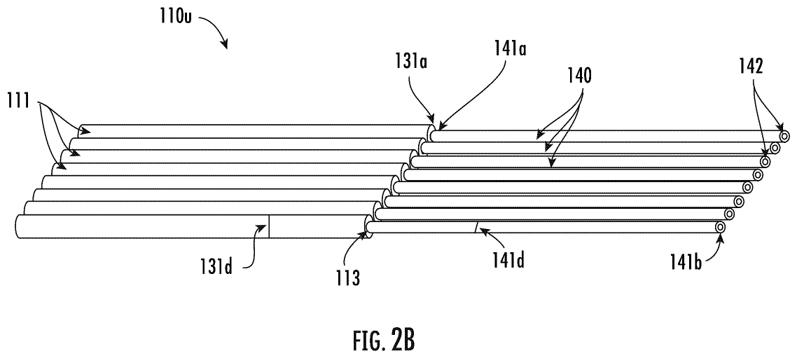

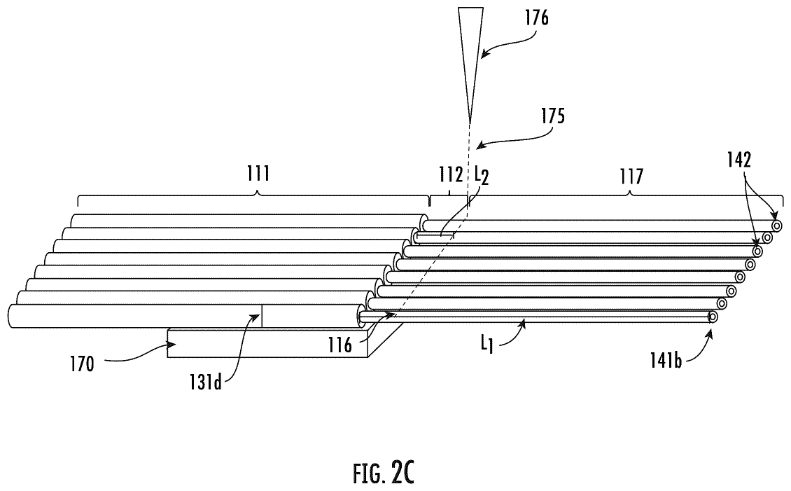

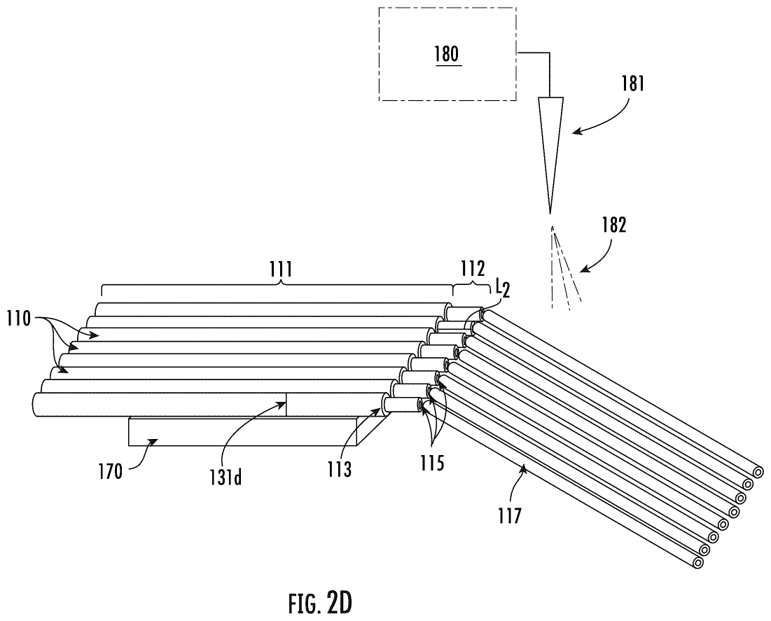

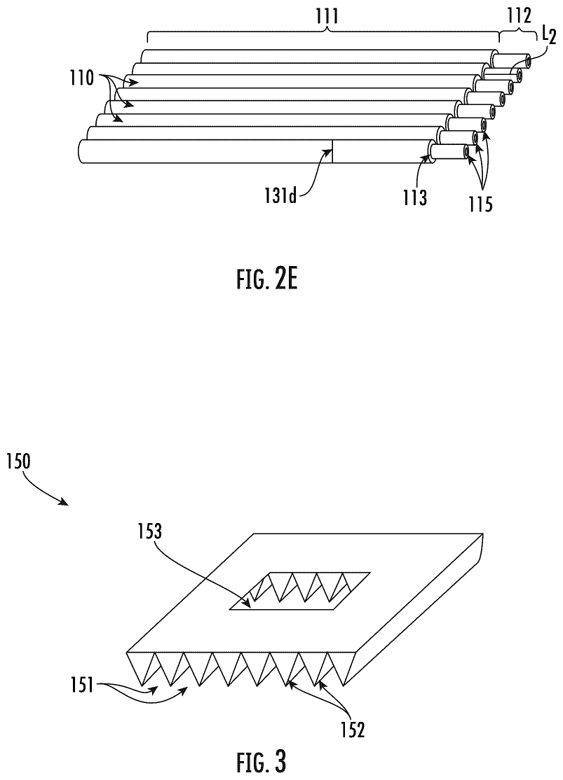

In some embodiments, the optical fiber 110 is a single fiber trimmed to the length L₃ to produce the desired output characteristics. In other embodiments, the optical fiber 110 may comprise a first optical fiber 111 and a second optical fiber 112 spliced together at a splice point 113. In some embodiments, a determined length L₂ (see e.g., FIG. 2C) of the second optical fiber 112 between the splice point 113 and the severed end 115 determine the output characteristics of the optical fiber 110, while in other embodiments, the length L₃ of the optical fiber 110 determines the output characteristics of the optical fiber 110.

FIGS. 2A-E illustrate example formation of the optical fiber 110 for use with the FAU 100. FIGS. 2A-2B illustrate an uncut optical fiber 110u being formed of a first optical fiber 111 having a first diameter 131d and a second optical fiber 140 having a second diameter 141d. In some embodiments, the first diameter 131d is the diameter of first optical fiber 111 including a core 132 and surrounding cladding 133. In some embodiments, the first optical fiber 111 may extend from the first end 110a, (see e.g., FIG. 1) to a second end 131a. The second optical fiber 140 may be positioned such that a core 142 of the second optical fiber 140 is aligned with the core 132 of the first optical fiber 111. The second optical fiber 140 may extend between a first end 141a and a second end 141b. In some embodiments, the second diameter 141d is the diameter the core 142 and the surrounding cladding 143 of the uncut optical fiber 140. In some embodiments, the first diameter 131d is larger than the second diameter 141d, while in other embodiments the first diameter 131d is substantially equivalent to the second diameter 141d.

In some embodiments, the second end 131a of the first optical fiber 111, and the first end 141a of the second optical fiber 140 are cleaved prior to splicing, to reduce imperfections, and promote durable splicing between the first optical fiber 111 and the second optical fiber 140. In some embodiments, the second optical fiber 140 may be trimmed, prior to splicing with the first optical fiber 111.

As illustrated in FIG. 2B, the first optical fiber 111 and the second optical fiber 140 may be spliced together, forming the splice point 113. The splice point 113 joins the core 132 of the first optical fiber 111 with the core 142 of the second optical fiber 140. In some embodiments, the first optical fiber 111 and the second optical fiber 140 may be fusion spliced, while in other embodiments, may be mechanically spliced. In a non-limiting example, the first optical fiber 111 and the second optical fiber 140 may be spliced with ribbon splicer, such as a Fujikura 70S+ ribbon splicer. Splicing the first end 141a of the second optical fiber 140 and the second end 131a of the first optical fiber 111 may form an optical variation portion L₁ (e.g., a length of the second optical fiber 140) for the uncut optical fiber 110u that may be used to determine the output characteristics of the optical fiber 110 once it is cut (e.g., cleaved, trimmed, polished back, etc.).

After splicing, the uncut optical fiber 110u may be trimmed to achieve the desired output characteristics. FIG. 2C illustrates the uncut optical fiber 110u placed on a translation stage 170. In some embodiments, the first optical fiber 111 may be positioned on the translation stage 170 while the second optical fiber 140, may be positioned off of the translation stage 170.

In some embodiments, the second optical fiber 140 may define the optical variation portion L₁. In some embodiments, the optical variation portion L₁ of the second optical fiber 140 may not yield the desired output characteristics (e.g., the optical variation portion is incorrectly sized). The optical variation portion L₁ may be trimmed to a position (e.g., the severed end 115) defining a determined length L₂, extending from the splice point 113 to the severed end 115, wherein the position of the severed end 115 along the optical variation portion L₁ produces the desired output characteristics.

In some embodiments, a first laser 176 may produce a laser beam 175 and may translate across the second optical fiber 140 to yield perforations 116 though the cladding 143 and the core 142 of the second optical fiber 140. The perforations 116 may divide the second optical fiber 140 into an excess portion 117 and the remaining second optical fiber 112.

In some embodiments, the first laser 176 may be a femtosecond laser, while in other embodiments, the first laser 176 may be a diode pumped laser. In some embodiments, the laser beam 175 may have a central wavelength between 900-1100 nm, between 950-1080 nm, and between 980-1040 nm. In some embodiments, the laser beam 175 may have a pulse width between 5-20 picoseconds, between 7-15 picoseconds, and between 9-11 picoseconds. In some embodiments, the laser beam 175 may have a repetition rate between 35-75 kHz, between 45-65 kHz, and even between 47-62 kHz. In an example embodiment, the laser beam 175 may have a central wavelength of 1030 nm, a pulse width of 10 picoseconds, and a repetition rate of 50 kHz.

In some embodiments, the laser beam 175 may define a pulse yielding 160 μJ. The first laser 176 may be configured such that the laser beam 175 produced is approximately 1 μm wide and 1 mm long. The first laser 176 may further be configured to move with a translation rate across the uncut optical fiber 140 of 20 mm/s. The translation rate may provide evenly spaced perforations 116 across the second optical fiber 140.

In an alternative embodiment, a parallel diamond cutter may be used to perforate the second optical fiber 140.

As illustrated in FIG. 2D, after the perforations 116 are formed a force 182 may be applied to the excess portion 117. In some embodiments, the force 182 may be in the form of compressed gas from a gas supply 180 dispensed from a nozzle 181. In some embodiments, the force 182 may be applied at a pressure between 15-65 psi, between 25-55 psi, or between 35-45 psi. In some embodiments, the external force is applied for between 50-500 ms, between 100-400 ms, or between 150-300 ms. In an example embodiment, the force 182 may be compressed air applied to the excess portion 117 at pressure of 40 psi, for about 200 ms. In some embodiments the force 182 is translated across the excess portion 117, while in other embodiments, the force 182 is configured to contact the entire excess portion 117.

The application of the force 182 to remove the excess portion 117 results in the optical fiber 110 having the determined length L₂ for the desired output characteristic, as illustrated in FIG. 2E. Accordingly, the optical fiber 110 may be adhered to the substrate, (see e.g., 120 in FIG. 1), creating the FAU, (see e.g., 100 in FIG. 1). In some embodiments, the FAU may be formed before the perforations are formed and/or before the excess portion 117 is removed.

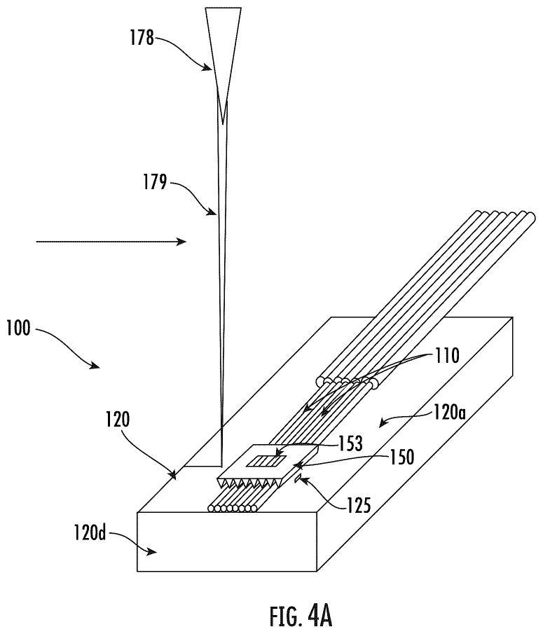

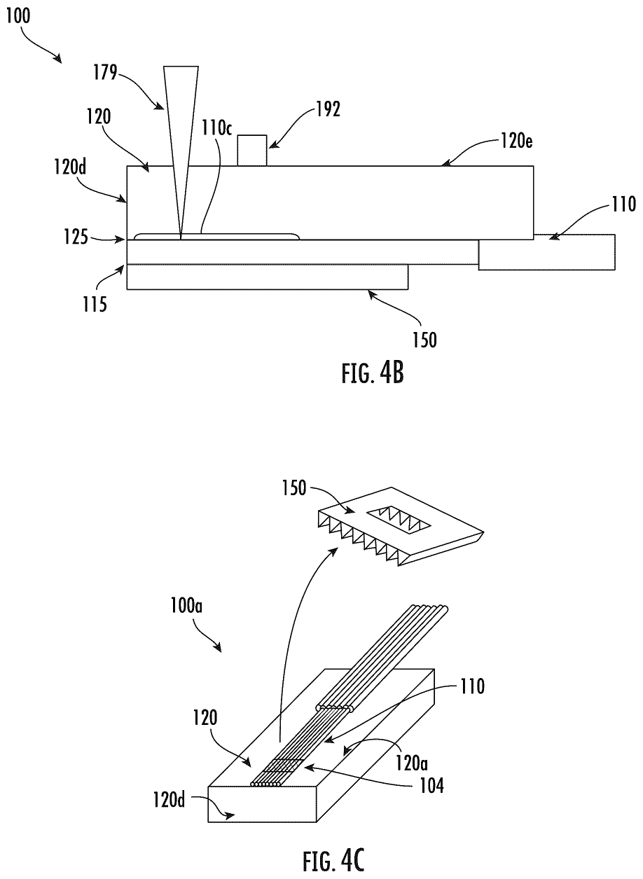

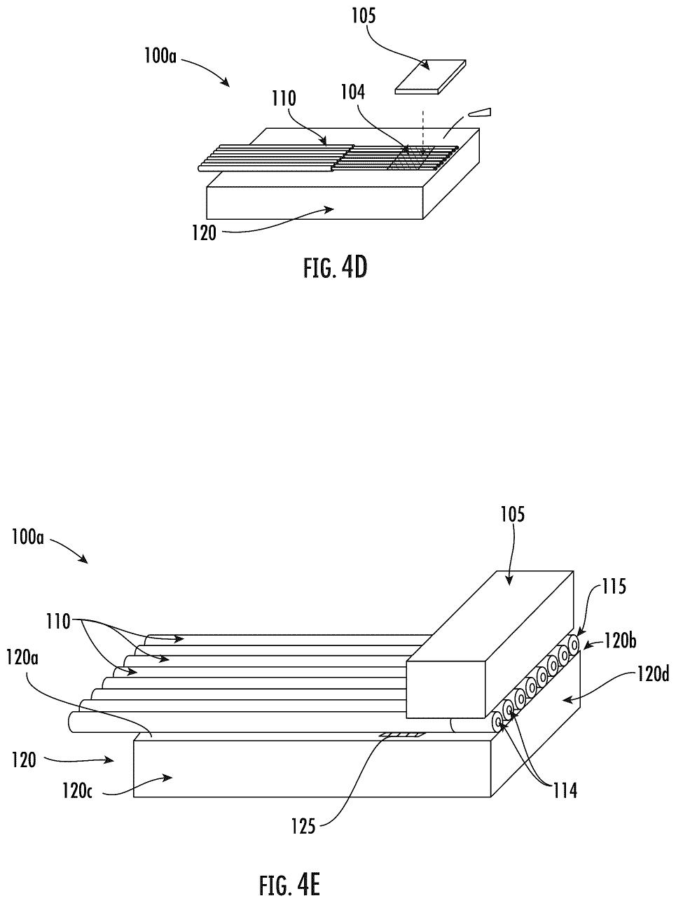

FIG. 3 illustrates an example fixture 150 configured to maintain the position of the optical fiber on the substrate before the laser welding process. The fixture 150 may comprise a bottom surface 152 configured to contact the surface 120a of the substrate 120 (see e.g., FIG. 4A). The bottom surface 152 may be configured with a plurality of grooves 151. In some embodiments, the plurality of grooves 151 may be configured as V-grooves to maintain the position of the optical fiber 110 on the surface 120a of the substrate 120 (see e.g., FIG. 4A). In some embodiments, the bottom surface 152 is configured to contact the surface 120a of the substrate 120 without engaging with the film 125 disposed on the surface 120a of the substrate 120 (see e.g., FIG. 4A).

In some embodiments an opening 153 may be positioned within the fixture 150. The opening 153 may be configured to expose at least the portion 110c of the optical fiber 110 (see, e.g., FIG. 4A). The plurality of grooves 151 are interrupted by the opening 153. In some embodiments, the opening 153 may be configured to span across the optical fiber 110 such that a laser, or other heat source, may directly contact the optical fiber 110, and in some embodiments the film below the optical fiber.

In some embodiments, the opening 153 may be a square, oval, circle, or other shape creating a solid fixture 150 while exposing the portion of the optical fiber to be bonded to the substrate. In some embodiments, the fixture 150 may be configured such that the portion of the optical fiber is completely exposed through the opening 153. The fixture 150 may be fabricated from any suitable material, for example glass, metal, silicone and/or polymers.

In some embodiments, the number of the plurality of grooves 151 may be greater than the number of optical fibers positioned on the surface of the substrate. For example, in an embodiment where the optical fiber is eight optical fibers, the plurality of grooves 151 may be greater than eight.

In some embodiments, the fixture 150 may be a solid apparatus. In some embodiments, the fixture 150 may be a solid apparatus defining the plurality of grooves 151 fabricated from a polymer, for example silicone. The silicon fixture 150 may be used to maintain the position and pitch of the optical fiber (see e.g., FIG. 4B) wherein the laser or other heat source is configured to enter through a bottom surface of the substrate, and propagate within the substrate at the film (see e.g., FIG. 4B).

In some embodiments, prior to bonding, the surface 120a of the substrate 120 may be prepared for bonding. In an example embodiment, the film 125 may be positioned on the surface 120a of the substrate 120. In some embodiments, the substrate 120 may be an Eagle XG glass substrate, and the film 125 may be an 80 nm stainless steel film. Upon application of the film 125 to the surface 120a of the substrate 120, the surface 120a and film 125 may be plasma treated, for example, with a handheld air-plasma source. After preparation, the portion 110c of the optical fiber 110 may be positioned on the film 125 on the substrate 120.

As shown in FIG. 4A, the fixture 150 is placed onto the surface 120a of the substrate 120 such that the bottom surface 152 contacts the surface 120a. In some embodiments, the fixture 150 is positioned such as to not contact the film 125 placed on the surface 120a of the substrate 120. The fixture 150 may be placed such that the optical fiber 110 is positioned within one of the plurality of grooves 151, thereby maintaining proper pitch. The plurality of grooves 151 position the optical fiber 110 at known locations of the x- and z-axis. As a non-limiting example, the precise placement of the fixture 150 on the substrate 120 may be performed by an active alignment process. In some embodiments, once the fixture 150 is positioned, the fixture 150 may be mechanically clamped or otherwise secured to the substrate 120.

As discussed above, the severed end 115 of the optical fiber 110 may be aligned with the end face 120d of the substrate 120. In some embodiments, the opening 153 of the fixture 150 may be positioned to expose the portion 110c of the optical fiber 110 to heat to thereby bond the portion 110c to the substrate 120. Thus, a second laser 178 may produce a second laser beam 179 which enter through the opening 153 and pass over (e.g., be translated across) the portion 110c (FIG. 1) of optical fiber 110 to bond the optical fiber 110 to the substrate 120. In some embodiments, the second laser beam 179 may define a wavelength of up to 1200 nm, up to 1180 nm, or in some embodiments, up to 160 nm. In some embodiments, the second laser beam 179 may define a power range between 1 W and 6 W, 1.5 W and 5.5 W, and even between 2 W and 5 W.

In some embodiments, the second laser beam 179 may pass over the opening 153 of the fixture 150 multiple times and, in some cases, along multiple paths thereby bonding the optical fiber 110 to the substrate 120 at multiple positions, while in other embodiments, a single pass may be sufficient to bond the optical fiber 110 to the substrate 120.

FIG. 4B illustrates the FAU 100 wherein the optical fiber 110 is bonded along the length L₃ of the optical fiber 110. In some embodiments, the optical fiber 110 may be bonded to the substrate 120 along the portion 110c of the optical fiber 110 contacting the film 125. In some embodiments, the optical fiber 110, substrate 120, and fixture 150, may be inverted such that the second laser beam 179 may pass through a bottom surface 120e of the substrate 120 to heat the film 125 thereby bonding the optical fiber 110 to the substrate 120. The fixture 150 may be positioned on the optical fiber 110 such that the plurality of grooves maintain the position and pitch of the optical fiber 110.

In some embodiments, pressure may be applied to the bottom surface 120c of the substrate 120 with a secondary fixture 192. In some embodiments, the secondary fixture 192 may be a block, a clamp, or apparatus for applying pressure thereby securing the substrate 120, film 125, optical fiber 110, and fixture 150 in a tight configuration during bonding.

In some embodiments, the second laser beam 179 may sweep over the length L₃ or a portion 110c of the length L₂ (see e.g., FIG. 2C) of the optical fiber 110. In some embodiments, utilizing the length L₃ of the optical fiber 110 as a bonding surface may form a tight bond between the severed end 115 and the substrate 120. In some embodiments, the resulting FAU 100 may define a more uniform pitch across one or more optical fibers 110. Additionally, bonding the optical fiber 110 to the surface 120a of the substrate 120 along the length L₃ of the optical fiber 110 yields a bond between the severed end 115 and the surface 120a of the substrate 120. In some embodiments, the severed end 115 being directly bonded to the surface 120a of the substrate 120 at the end face 120d provides uniform pitch (e.g., tight vertical height positioning) throughout the FAU 100, thereby preventing the need for an additional dicing step. For example, instead of needing to dice off a portion of the FAU 100 leading up to the bonded section (e.g., at film 125), the FAU 100 need not be diced because the severed end 115 is already bonded.

As illustrated in FIG. 4C, after the optical fiber 110 is bonded to the substrate 120, the fixture 150 may be removed from the surface 120a of the substrate 120. In some embodiments, an adhesive 104 may be disposed across the portion 110c of the optical fiber 110 after bonding to the substrate 120. In some embodiments, the adhesive 104 is an epoxy, or other suitable adhesive with low coefficient of thermal expansion.

After application of the adhesive 104, the adhesive 104 may be thermally or UV cured, as illustrated in FIG. 4D. A lid 105 may be placed on to the adhesive 104, thereby creating a lidded FAU 100a. FIG. 4E illustrates a perspective view of the completed lidded FAU 100a.

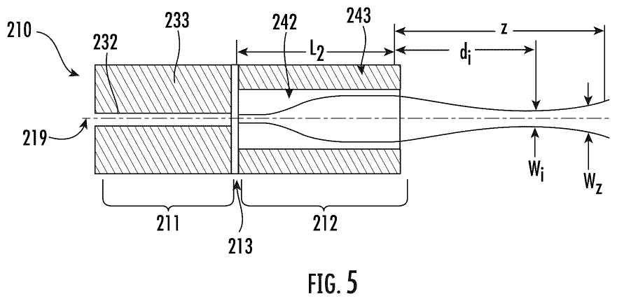

FIG. 5 illustrates a cross-sectional view of an optical fiber 210. The optical fiber 210 comprises a first optical fiber 211 and a second optical fiber 212 spliced together at a splice point 213. As illustrated the first optical fiber 211 is a single modal fiber, and the second optical fiber 212 is a multi-mode fiber. The first optical fiber 211 defines a first cladding 233 surrounding a first core 232. Similarly, the second optical fiber 212 defines a second cladding 243 surrounding a second core 242. The addition of the second optical fiber 212 allows a user to choose a desired output characteristic, via lensing (e.g., the second optical fiber 212 forms an optical variation portion of the optical fiber 210). In some embodiments, a determined length L₂ of the second optical fiber 212 may define the output characteristics of the optical fiber 210, without which the lensing output of the optical fiber 210 would diverge. The determined length L₂ may be calculated to produce either a focusing or collimating ray 219.

To determine the determined length L₂, first, the refractive index profile of the fiber may be approximated as:

$${n}^{2} ( r ) = {n}_{0}^{2} [ 1 - {( {g}_{0} r )}^{2} ]$$

Where r is the radial distance from the optical axis, n₀ is the optical axis refractive index, and g₀ is the quadratic index constant of the second optical fiber 212. In some embodiments, the pitch P of the optical fiber 210 (neglecting aberrations) may be calculated as:

$$P \approx \frac{2 π}{{g}_{0}}$$

The fractional pitch may be calculated as:

$$η = \frac{L}{P}$$

The beam waist w_{z} may be calculated as:

$${w}_{z} = {{w}_{0}^{2} [ cos ( 2 πη ) - {n}_{0} {xg}_{0} sin ( 2 πη ) ]}^{2} + {{a}^{2} [ \frac{sin ( 2 πη )}{{g}_{0}} - {n}_{0} x cos ( 2 πη ) ]}^{2} ;$$

$$a = \frac{λ}{π {n}_{0} {w}_{0}^{2}}$$

The image distance dᵢ and image magnification m₀ may be calculated by:

$${d}_{i} = \frac{sin ( 4 πη ) ( {g}_{0}^{2} - {a}^{2} )}{2 {n}_{0} {g}_{0} [ {g}_{0}^{2} {sin}^{2} ( 2 πη ) + {a}^{2} {cos}^{2} ( 2 πη ) ]} ;$$

$${m}_{g} = \frac{{w}_{i}}{{w}_{0}} = \frac{1}{\{ {( \frac{{g}_{0} sin ( 2 πη )}{a} )}^{2} + {cos}^{2} ( 2 πη ) \} \hat{} 1 / 2}$$

The divergence/acceptance angle 40 may be calculated as:

$$Δθ = \frac{λ}{π {w}_{0} {m}_{g}}$$

FIGS. 6A-C illustrate various optical fiber configurations and the resulting output characteristics. FIG. 6A illustrates an optical fiber 301 without any lensing, yielding a diverging beam. FIG. 6B illustrates an optical fiber 302 with a lensing configuration yielding a collimating beam. FIG. 6C illustrates an optical fiber 303 with a lensing configuration to yield a focusing beam. As depicted, the collimating beam, and the focusing beam lensing configurations allow for a greater transmission of the beam from the optical fiber into the receiving fiber.

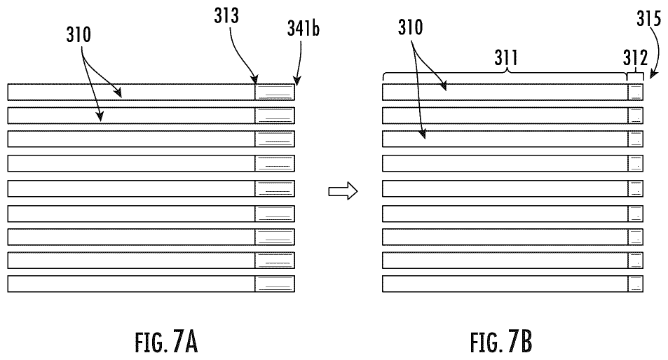

In some embodiments, the desired characteristics of optical fiber may be accomplished by polishing back an end of the optical fiber, rather than laser perforations as described in FIGS. 2A-2E. As illustrated in FIGS. 7A-B, a first optical fiber 311 and a second optical fiber 312 may be spliced together at a splice point 313 forming optical fiber 310. The second optical fiber 312 may define a second end 341b opposite the splice point 313. In some embodiments, the second end 341b may be polished back to a severed end 315 of the second optical fiber 312 to yield the desired output characteristic.

In some embodiments, the optical fiber 310 may be polished back, such that the severed end 315 may be vertical, while in other embodiments, the severed end 315 may be angled, wherein the angle defines the desired output characteristics. In some embodiments, the angle may be formed within a portion of the cladding, and in other embodiments, the angle may be formed through the optical fiber (e.g., the cladding and the core).

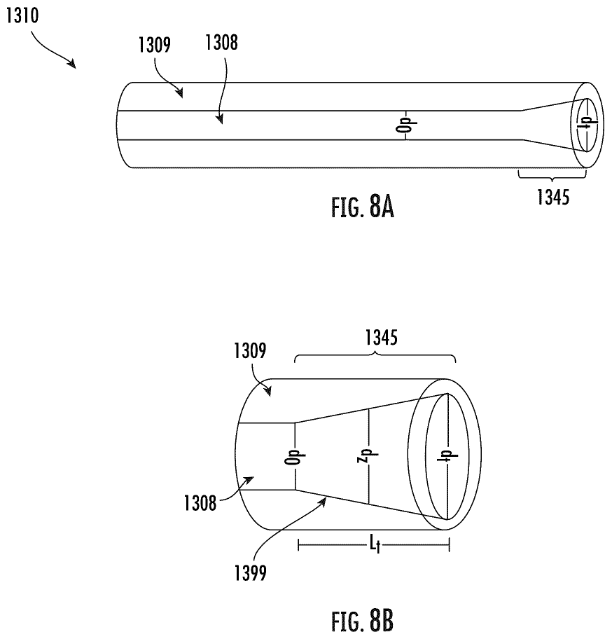

In some embodiments, the output characteristics may be determined by a tapered diameter in a core of an optical fiber. An expanded beam (EB) optical fiber, and FAU, may use a tapered diameter as an alternative way to make a “quasi-collimated” beam. With reference to FIGS. 8A-8B, an expanded beam optical fiber 1310 may be created by forming a taper 1345 in a single mode optical fiber. In some embodiments, the taper 1345 is an adiabatic taper. The taper 1345 may be created by making a well-controlled index profile by thermal diffusion of core dopant elements in the single mode optical fiber. In some embodiments, the taper 1345 may be created by heating Ge-doped fibers as disclosed within U.S. Patent Application No. 63/249,855, entitled “Fiber Optic Connectors Having a Sealing Membrane Disposed on the Connector Housing”, filed Sep. 29, 2021, which is assigned to the Assignee and Applicant of this application, and which is incorporated by reference herein in their entirety. In some embodiments, the taper 1345 may yield wide output beams between 10-60 μm, between 20-50 μm and even between 30-40 μm.

In some embodiments, halides may be used to dope a core 1308 and cladding 1309 of the expanded beam optical fiber 1310. The higher diffusivity and interdiffusion of Chlorine and Fluorine may reduce the amount of the heating and temperatures required to achieve the taper 1345. In some embodiments, heating may be achieved in a fusion splicer.

In some embodiments, the taper 1345 between the core 1308 and cladding 1309 may define a slope 1399 extending along a taper length Lₜ to a severed end 1315 of the expanded beam optical fiber 1310. In some embodiments, the slope 1399 satisfies the following conditions:

$$\frac{dD}{dz} \leq 2 ( \frac{D}{λ} ) * ( {n}_{eff} - {n}_{cl} )$$

where D is the core diameter at a position z (e.g., d_{z}) within the taper 1345, λ is the operating wavelength, n_{eff} is the effective index of the fundamental mode, and n_{cl} is the refractive index of the cladding 1309. The effective index of the core 1308 can be calculated from the relation:

$${n}_{eff} = \frac{{D}_{b}}{2 p}$$

$${D}_{b} = {b}_{1} - {b}_{2}$$

where b₁ and b₂ are propagation constants for the fundamental and the second local mode. The taper 1345 may define a minimum diameter d₁, and a maximum diameter d₂ across the taper length Lₜ. In some embodiments, the slope 1399 of the taper 1345, may be less than 100 microns/mm. In other embodiments, the slope 1399 of the taper 1345 may be less than 50 microns/mm. In yet other embodiments, the slope 1399 of the taper 1345 may be less than 25 microns/mm.

In some embodiments, the relatively short taper length L₁ of the taper 1345 suggests that one of the potential ways it can be prepared is in a commercial splicer by splicing a bridge fiber to itself and cleaving a splice at the center point. This is one of economical ways to make the parts from halide fiber.

As discussed above, in some embodiments, such as in the optical fiber with the lens (see e.g., 110 of FIG. 2E), the output characteristics are controlled by the determined length L₂ of the second optical fiber 112 (see e.g., FIG. 2E), while in the expanded beam optical fiber 1310 the output characteristics are controlled by the parameters (e.g., slope and length) of the taper 1345. In some such embodiments, the taper 1345 may be severed to form a severed end at a desired distance along the taper 1345 to form the desired output characteristics therealong.

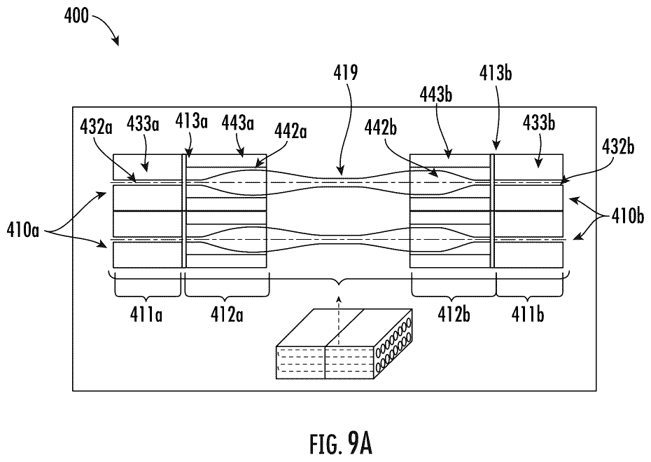

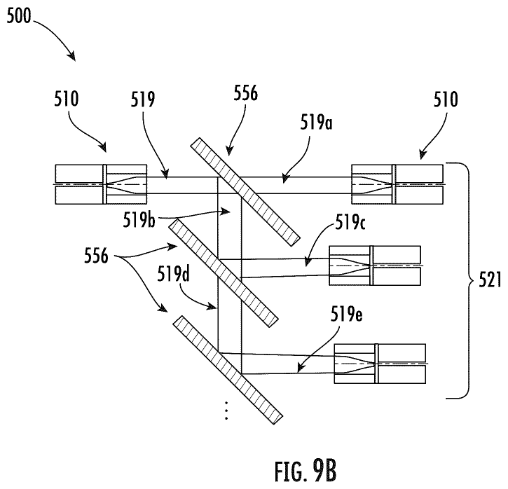

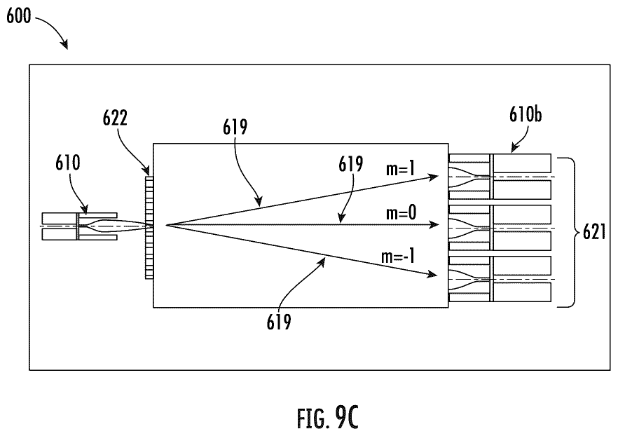

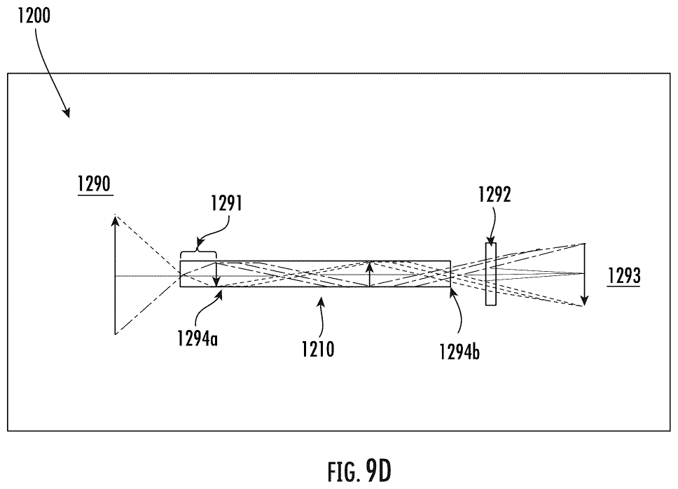

FIGS. 9A-D illustrate example applications of an FAU formed from the optical fiber as described with reference to FIG. 1. FIG. 9A illustrates an assembly 400 connecting a first optical fiber array 410a, each formed from a first optical fiber 411a spliced to a second optical fiber 412b to a second optical fiber array 410b, each formed from a first optical fiber 411b spliced to a second optical fiber 412b. In an embodiment, the assembly 400 is a 2D fiber array connector, formed using fluid assisted laser drilling. A ray 419 may propagate within a core 432a of the first optical fiber 411a and may be transmitted to a core 442a of the second optical fiber 412a. The assembly 400 may be used to transmit the ray 419 to propagate within a second core 442b of the second optical fiber 412b, and further to transmit the ray 419 to a second core 433b of the first optical fiber 411b. In some embodiments, due to the structure of the at least one first optical fiber 410a and the at least one second optical fiber 410b, the longitudinal dimension may have a more forgiving tolerance of slight offsets.

FIG. 9B illustrates another example assembly 500, for example a spatial demultiplexer. The assembly 500 may include a plurality of beam splitting internal structures 556. An optical fiber 510 may produce a ray 519. The ray 519 may pass through one of the plurality of beam splitting internal structures 556 and split into a transmitted ray 519a, 519c, 519e and a reflected ray 519b, 519d. The transmitted rays 519a, 519c, 519e may propagate within an FAU 521. In some embodiments, the FAU 521 may comprise at least one optical fiber 510b, wherein the number of optical fibers 510b corresponds to the number of the plurality of beam splitting internal structures 556. As discussed above, the use of the first optical fiber spliced to the second optical fiber (see e.g., 111 and 112 of FIG. 1) allows a longitudinal offset tolerance.

FIG. 9C illustrates another example assembly 600, utilizing a grating demultiplexer 622. The assembly 600 utilizes a ray 619 from an optical fiber 610. The ray 619 passes through the grating demultiplexer 622 and expands to propagate in an FAU 621. The FAU 621 may comprise at least one optical fiber 610b to receive the ray 619. The FAU 621 configurations may utilize the large acceptance angles within the at least one optical fiber 610b.

FIG. 9D illustrates an example imaging assembly 1200. The imaging assembly 1200 may project an object 1290 to be seen through an optical fiber 1210, through an objective lens 1291. The object 1290 may be reflected from a first end 1294a to a second end 1294b. The object 1290 is focused through a relay lens 1292 to create an image 1293 of the object 1290.

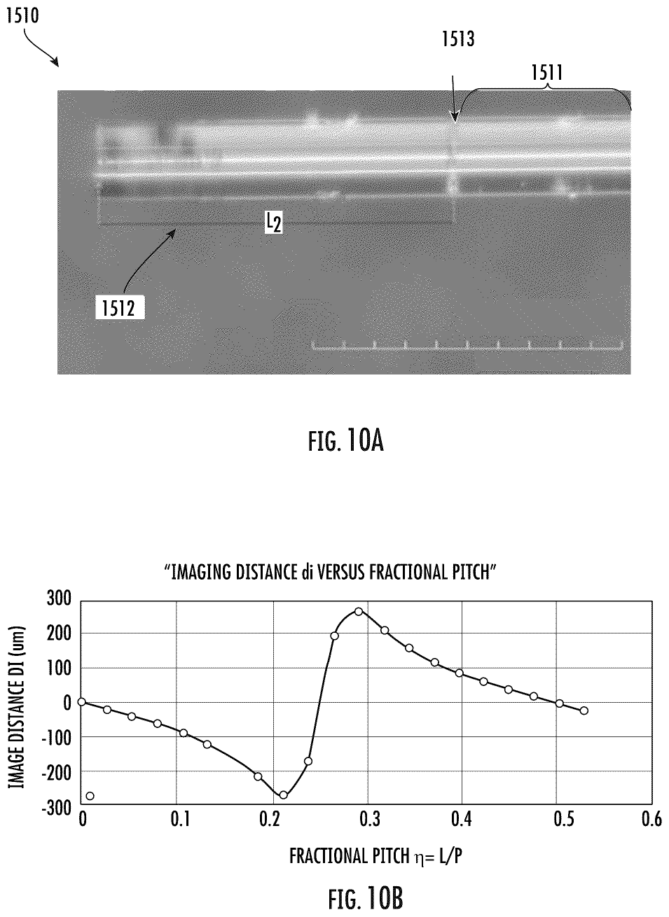

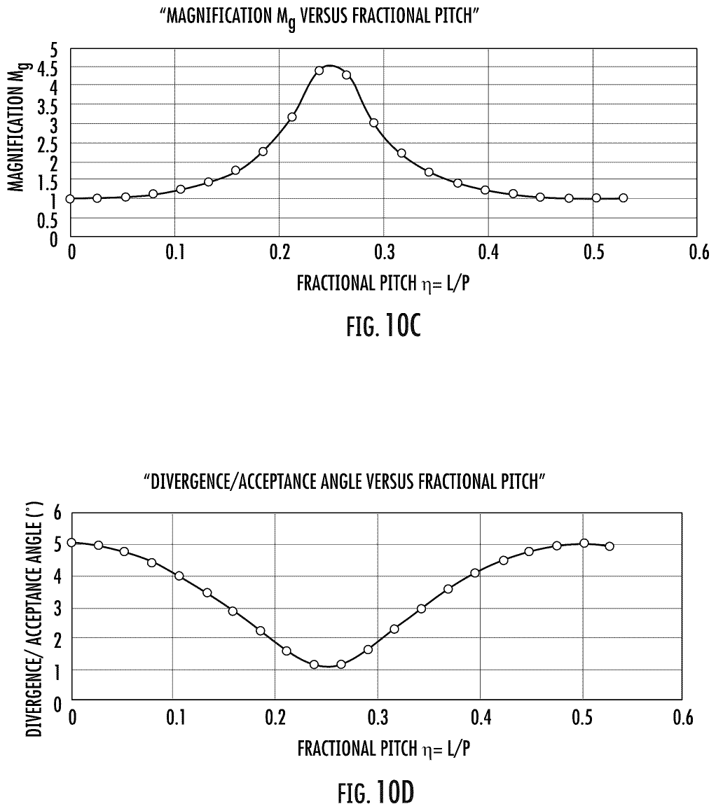

FIG. 10A illustrates a photograph of an optical fiber 1510 comprising a first optical fiber 1511 spliced to a second optical fiber 1512 at a splice point 1513. The first optical fiber 1511 is a single mode fiber, while the second optical fiber 1512 is a gradient-index multimode fiber (GRIN-MMF). The second optical fiber 1512 is a determined length L₂, which defines the output characteristics of the optical fiber 1510. The determined length L₂ is about 575 μm yielding a fractional pitch η˜0.507.

FIGS. 10B-C illustrate theoretical plots for imaging properties of the optical fiber 1510 having a paraxial GRIN design lens formula, for example those described with reference to FIG. 5, utilizing a wave length λ=633 nm. FIG. 10B illustrates a plot for the image distance, di (in microns) versus fractional pitch, η. FIG. 10C illustrates a plot for image magnification, mg versus fractional pitch, η. FIG. 10D illustrates divergence/acceptance angle, Δθ versus fractional pitch, η.

In some embodiments, as illustrated in FIG. 10D, the fractional pitch region between 0.25 and 0.30 is generally used for focusing behavior with divergence angles of the order of 1°-2°. The image distance in this region, as illustrated in FIG. 10B, resides outside the spliced end (see e.g., 115 of FIG. 1) of the optical fiber (see e.g., 110 of FIG. 1), up to 274 μm with the first optical fiber and second optical fiber (see e.g., 111, 112 of FIG. 1). As discussed, the first optical fiber may be a single mode fiber, and the second optical fiber may be a multimode fiber, specifically a gradient index (GRIN) multimode fiber.

In some embodiments, the “focal length” may be varied by selecting the GRIN multimode fiber with a different refractive index, nₒ and quadratic index constant gₒ. For example, a multimode fiber with a nₒ=1.4815, and gₒ=4.05 mm may yield an image distance, dᵢ as high as 516 μm, almost twice the effective focal length as before.

For light-capture applications requiring large acceptance angles the fractional pitch, η may be as high as 0.507. Therefore, with a fractional pitch, η between 0.45 and 0.55, as illustrated in FIG. 10D the divergence/acceptance angle is near the maximum of 5°, while the image distance, illustrated in FIG. 10B remains near the spliced end of the optical fiber (see e.g., 115, 110 of FIG. 1). The fractional pitch, η between 0.45 and 0.55 further bears little magnification, as illustrated in FIG. 10C. In this regard, it can be shown that utilizing a GRIN lens and selecting where to position the severed end provides for customizing the desired output characteristics.

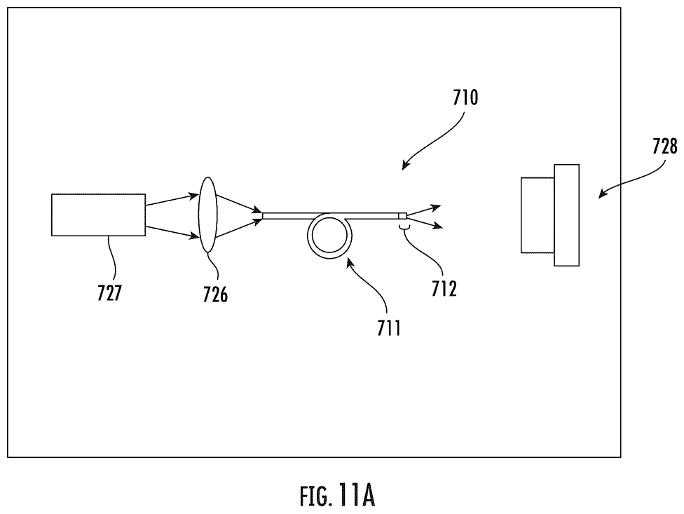

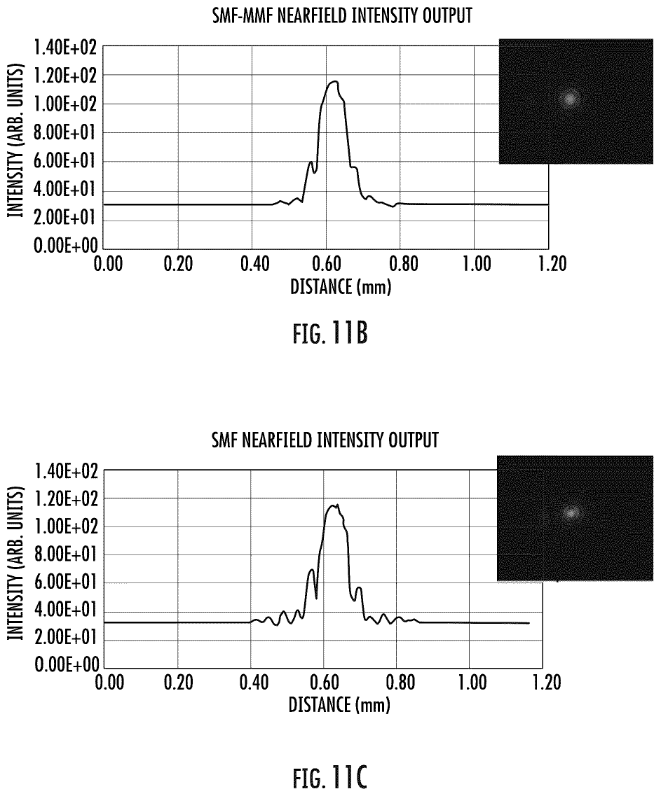

FIG. 11A illustrates a system 700 for characterizing near field output of a GRIN fiber. A laser 727, for example a Melles-Griot, may be coupled into an optical fiber 710 through a lens 726. In some embodiments, the lens 726 may be magnified 20X, with a NA of about 0.4. After passing though the optical fiber 710, the resulting light may be imaged into the near-field with a second lens 728. In some embodiments, the second lens 728 may be a macrolens. In some embodiments, the optical fiber 710 may be only a single mode fiber 711, and in other embodiments, the optical fiber 710 may be a single mode fiber 711 spliced to a multimode fiber 712.

FIGS. 11B-C illustrate a comparison of a single mode fiber, and a single mode fiber spliced with a multimode fiber, both displaying a fractional pitch, η between 0.45 and 0.55. FIG. 11B illustrates the output from the optical fiber 710 including the single mode fiber 711, and the multimode fiber 712 (see e.g., FIG. 11A), defining a fractional pitch between 0.45 and 0.55. FIG. 11C illustrates the output from the optical fiber 710, wherein the optical fiber includes only the single mode fiber 711 (see e.g., FIG. 11A). Notably, the optical fiber 710 containing the second optical fiber 712 displays a more uniform intensity at a distance between 0.4 and 0.8 nm, as compared to the optical fiber with only a single mode fiber at the same distance.

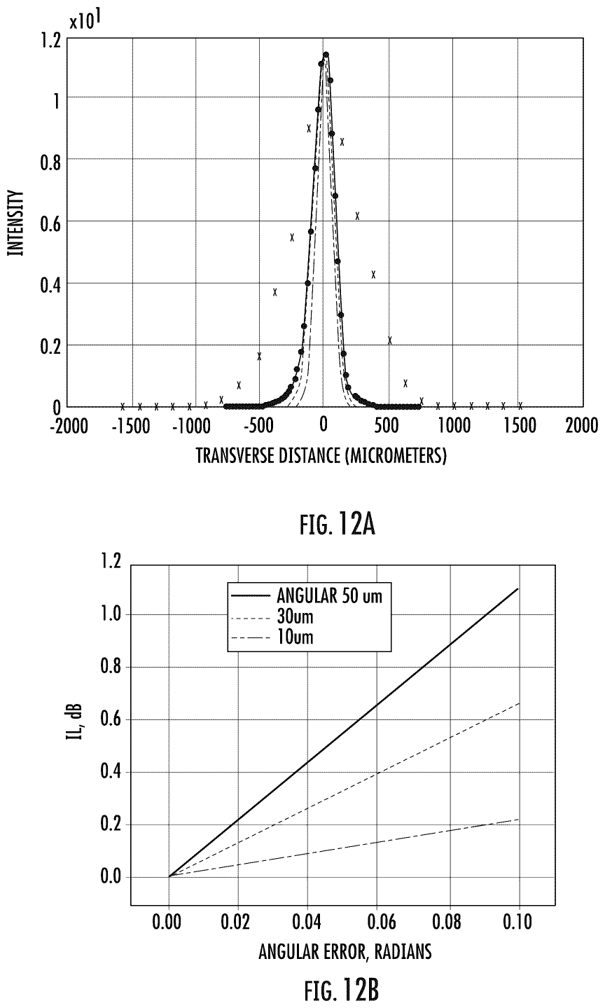

An essential element of modern fiber connectivity requirements is the ability to ensure minimal connector-connector light coupling loss. In order to minimize the loss, the output angles of the optical fibers within FAU's need to be controlled. In some embodiments, the alignment of the optical fibers of the connector for the coupling loss may be a function of lateral, longitudinal, and tilt angle offsets. Analysis of the impact of these fiber-to-fiber offsets suggests that the optimal mode field diameter (MFD) may be around 30-50 μm, which is achievable with both GRIN fiber and EB fiber approaches. The sensitivity for angular alignment becomes critical however, as illustrated in FIGS. 12A-B, suggesting a global optimum may be feasible by either the V-groove welding approach or LW approach.

FIG. 12A illustrates an example plot of characterization of far-field intensity distribution for an integrated GRIN fiber receiver with a 0.23 pitch fiber lens. The plot illustrates a GRIN fiber output near the optimum focus length, with a fractional pitch, η=0.25. In the plot the “o” points are measured from a distance of 8 mm from the severed end (e.g., 115 of FIG. 1), illustrating the expected distribution of the image for a 0.25P lens. The “x” points represent points from an unlensed single mode fiber at an 8 mm distance. The single mode fiber displays a wider range of intensity across the traverse distance.

FIG. 12B illustrates an example plot of insertion loss of a fiber as compared to the fiber-fiber tilt angle error at different mode filed diameters. As minimizing insertion loss is a key focus of fiber-fiber coupling, it is instructive to examine the fiber-to-fiber coupling loss variations due to different mode field diameters (MFD), fiber-to-fiber offset and tilt angular error utilized. For example, FIG. 12B suggests the smaller the MFD, the less sensitivity there is for angular misalignment. In some embodiments where an insertion loss of no more than 0.25 dB may be acceptable, then as illustrated, the use of GRIN-lens with a 30 μm MFD may tolerate up to 0.11 radians (6.3°) angular tilt error, while a GRIN-lens with a 50 μm MFD may only tolerate up to 0.023 radians (1.3°).

However, in some embodiments, too small of an MFD, may incur a higher loss if any lateral offset occurs during the connection process. The loss may be in part due to fiber-to-fiber transmission dependence on the lateral offset:

$$T = {e}^{- offset * 2}$$

where offset is defined as the ratio between the lateral separation d between fiber axes and the MFD/2:

$$offset = \frac{d}{\frac{MFD}{2}}$$

A trade-off of expanding the beam MFD with the GRIN-lens pitch, yet not so big as to incur large insertion losses from angular misalignment during the connection process, is appreciated from an optical engineering design perspective. The laser bonding process, as described above with reference to FIGS. 4A-E utilize a reusable v-groove fixture to ensure fabrication of FAUs with fiber-to-fiber 250-μm pitch tolerance, with less than 0.7 μm deviation. The FAUs as described may define a minimal lateral offset and tilt angular error.

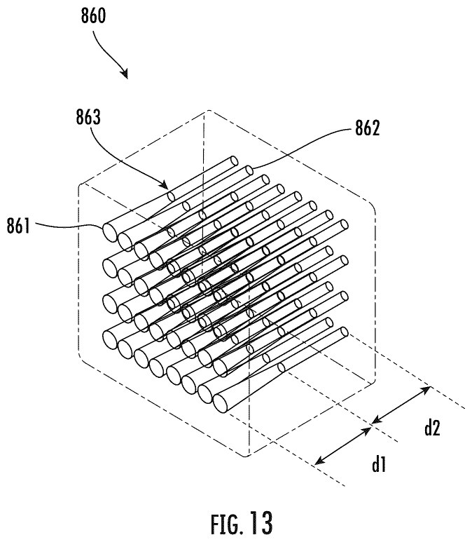

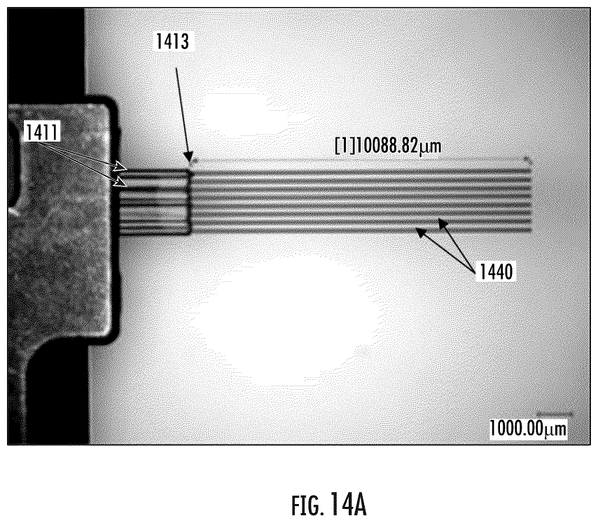

A 2D connector, illustrated, for example, in FIG. 13, may be used to connect one or more optical fibers as discussed above. A connector 860 may be formed with precision holes 861, 862. In some embodiments, the precision holes 861, 862 may be formed with a conical expansion, thereby aiding in insertion of optical fibers. The diameter control of the conical expansion may provide critical alignment between optical fibers placed within the precision holes 861, 862. In some embodiments, the accuracy of the placement of the precision holes 861, 862 may be limited by the equipment used, for example, a liquid assisted laser drilling machine (e.g., fabricated by Aerotech, and/or ALIO). In some embodiments, the accuracy of the precision holes 861, 862 is greater than 1 μm. The accuracy may further be impacted by the roughness of precision holes 861, 862.

To connect the optical fibers, the connector 860 should be fabricated with high precision. In an example embodiment, the connector 860 may have a rough interior of the precision holes 861, 862. The roughness may be about 300 nm, along a length d₁, d₂ of the precision holes 861, 862. The angular variation of the precision holes 861, 862 may be defined by:

$$Δα = arctan ( \frac{waviness}{length} )$$

In the example embodiment, the angular variation would be about 0.017º, thereby keeping the insertion loss at approximately 0.2 dB or lower depending on the mode diameter.

Although the connector 860 is described as a 2D ferrule, the connector 860 may be reduced to a 1D arrangement by limiting the number of optical fibers to a single layer.

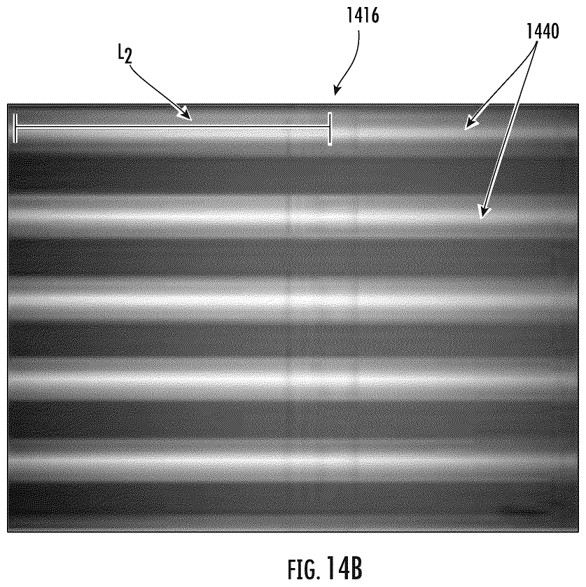

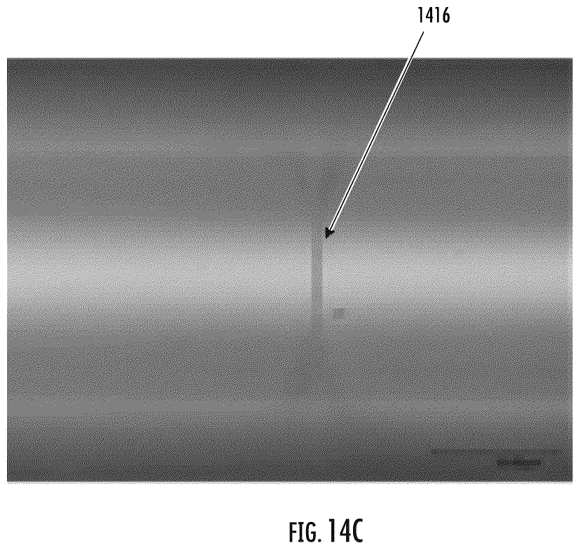

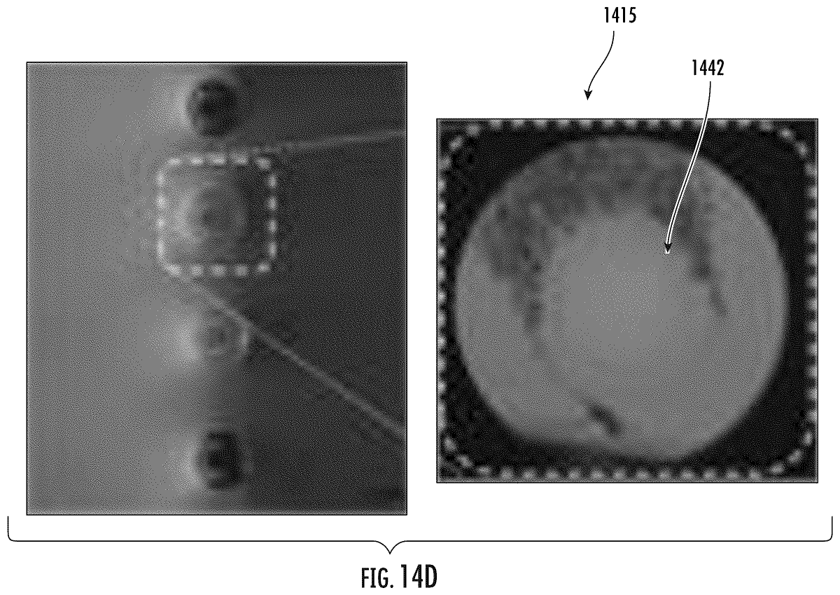

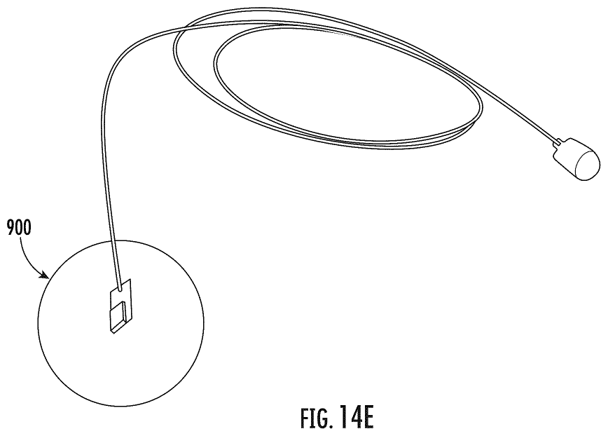

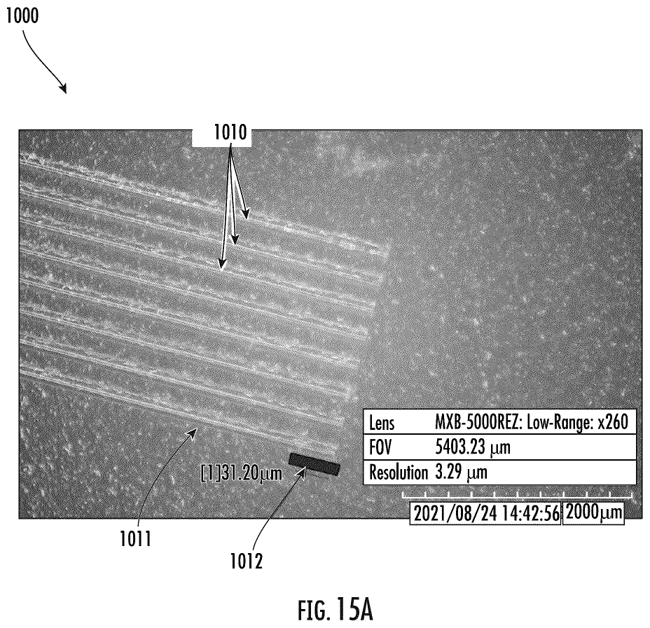

FIGS. 14A-E illustrate photographs of example FAU's in accordance with the present disclosure. FIG. 14A illustrates an example cleaved 8-fiber ribbon 1411 fusion spliced at a splice point 1413 to a custom 8-fiber ribbon 1440 prepared from a gradient-index multimode fiber, for example a 50/125 μm fiber spliced by a Fujikura 70S+ ribbon splicer. FIG. 14B illustrates a photograph of perforations 1416 formed within the custom 8-fiber ribbon 1440 to reduce the custom 8-fiber ribbon 1440 to a determined length L₂ to obtain the desired output characteristics. FIG. 14C illustrates a close-up photograph of the perforations 1416 across one of the fibers in the custom 8-fiber ribbon 1440. FIG. 14D illustrates a photograph of a severed end 1415 of the custom 8-fiber ribbon 1440. The image illustrates the surface of the severed end 1415 having a clean break about a core 1442. FIG. 14E illustrates an example packaged FAU 900 utilizing the cleaved 8-fiber ribbon 1411 fusion spliced to the custom 8-fiber ribbon 1440.

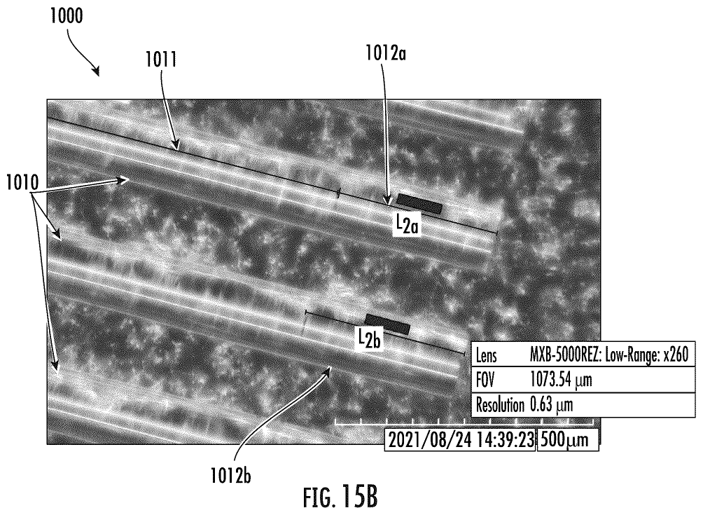

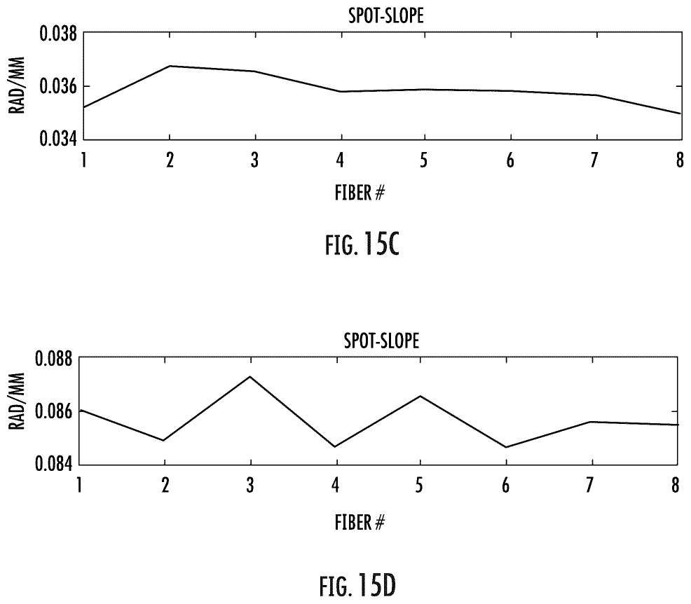

FIGS. 15A-D illustrate example FAUs and the respective spot slopes of the cores of each optical fiber within the FAU. FIG. 15A illustrates a photograph of an image of the GRIN fibers 1012 spliced to an 8-ribbon fiber 1011. FIG. 15B illustrates a close-up photograph of FIG. 15A of the GRIN-fiber ribbon splice point 1013. As illustrated two of the GRIN fibers 1012 were measured. A first GRIN fiber 1012a was measured with a first determined length L₂ₐ of about 320 μm, and a second GRIN fiber 1012b was measured with a second determined length L_{2b} of about 318 μm. The first GRIN fiber 1210a and the second GRIN fiber 1210b correspond to fractional pitches 0.282 and 0.280 respectively, assuming a GRIN pitch=1.134 mm at 630 nm.

FIGS. 15C-D illustrate example beam spot divergence angle comparisons. FIG. 15C illustrates the beam spot diversion for an FAU utilizing a GRIN lens, while FIG. 15D illustrates the beam spot diversion for a single mode fiber. As illustrated the GRIN-FAU, for example 100 in FIG. 4E, the spot slope is more consistent across each of the at least one optical fibers (e.g., 110 of FIG. 4E). The average divergence angle of the GRIN-FAU is about 0.036 radians, which is approximately 2°. In contrast the single mode optical fiber returns an average divergence angle of about 0.086 radians, which is approximately 5°. Therefore, the GRIN-FAU displays a lower, and more consistent divergence angle allowing for more consistent data transfer through the optical fibers.

### Example Flowchart(s)

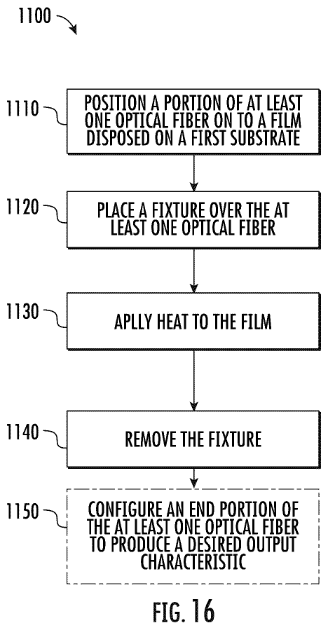

FIG. 16 is a flowchart illustrating an example method 1100 for forming an FAU in accordance with some embodiments herein. At operation 1110, a portion of at least one optical fiber is positioned on to a film disposed on a first substrate. At operation 1120, a fixture is placed over the at least one optical fiber. At operation 1130, heat is applied to the film disposed on the first substrate. At operation 1140, the fixture is removed from the surface of the first substrate. Optionally at operation 1150, an end portion of the at least one optical fiber is configured to produce a desired output characteristic.

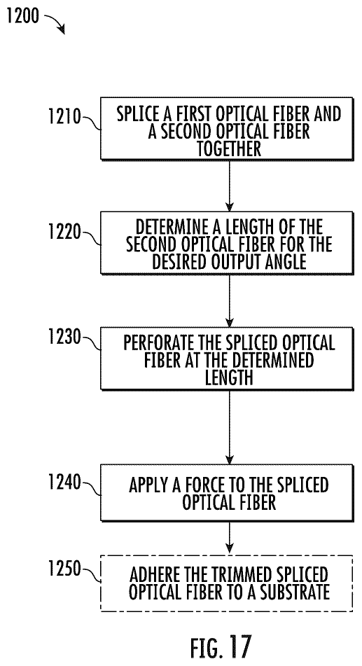

FIG. 17 is a flowchart illustrating an example method 1200 for forming an FAU in accordance with some embodiments discussed herein. At operation 1210, a first optical fiber and a second optical fiber are spliced together. At operation 1220, a determined length is determined for the second optical fiber to produce the desired output angle. At operation 1230, the spliced optical fiber is perforated at the determined length. At operation 1240, a force is applied to the spliced optical fiber, for example to a portion of the optical fiber opposite the splice point. Optionally at operation 1250, the severed optical fiber may be adhered to a substrate.

Notably, the above operations for FIGS. 16 and 17, while described in a certain order, may be performed in a different order and/or some of the operations may be performed simultaneously.

It will therefore be readily understood by those persons skilled in the art that embodiments of present disclosure are susceptible of broad utility and application. Many embodiments and adaptations of the present disclosure other than those herein described, as well as many variations, modifications and equivalent arrangements, will be apparent from or reasonably suggested by the present disclosure and the foregoing description thereof, without departing from the substance or scope thereof. Accordingly, while the embodiments of the present disclosure have been described herein in detail in relation to its preferred embodiment, it is to be understood that this disclosure is only illustrative, exemplary, and made merely for purposes of providing a full and enabling disclosure. The foregoing disclosure is not intended or to be construed to limit or otherwise to exclude any such other embodiments, adaptations, variations, modifications and equivalent arrangements.

That which is claimed:

1. A method of forming a fiber assembly, the method comprising:
removing an excess portion from an end of one of a plurality of optical fibers;
forming a severed end from an end of the plurality of optical fibers that defines an output characteristic of optical signals carried by the optical fiber, wherein the plurality of optical fibers defines an optical variation portion leading to the severed end, wherein the optical variation portion includes an optical pathway, and wherein the output characteristic of the optical signals varies depending on a position along the optical variation portion;
positioning a portion of one of the plurality of optical fibers with the severed end onto a film disposed on a surface of a substrate;
placing a fixture over one of the plurality of optical fibers such that a bottom surface of the fixture is in contact with the surface of the substrate, wherein the fixture defines an opening over the portion;
applying heat to the film under the portion through the opening of the fixture to create a bond between the portion and the surface of the substrate; and
removing the fixture from the surface of the substrate.

2. The method of claim 1, wherein the plurality of optical fibers comprises multi-mode fiber.

3. The method of claim 1, wherein removing the excess portion comprises:
forming perforations along one of a plurality of optical fibers;
severing the perforations to define the excess portion;
applying a force to the excess portion; and
removing the excess portion to form the severed end.

4. The method of claim 3, wherein the step of forming perforations along one of a plurality of optical fibers comprises lasering with a femtosecond laser.

5. The method of claim 3, further comprising applying the force with compressed air.

6. The method of claim 1, wherein the plurality of optical fibers comprises a first optical fiber and a second optical fiber, wherein the second optical fiber defines the optical variation portion of the optical fiber.

7. The method of claim 6, further comprising splicing the first optical fiber to the second optical fiber at a splice point.

8. The method of claim 6, wherein the second optical fiber comprises multimode fiber.

9. The method of claim 6, wherein the second optical fiber defines a cleaved gradient index (GRIN) lens.

10. The method of claim 1, further comprising:
doping the optical variation portion with a halide; and
heating the severed end to form a taper, wherein a slope of the taper defines the output characteristic of optical signals carried by the optical fiber.

11. The method of claim 10, wherein the halide is one of chlorine, fluorine, or germanium.

12. The method of claim 1, wherein the output characteristic of optical signals is one of collimating, diverging, or focusing.

13. The method of claim 1, further comprising forming a fiber array unit with the plurality of optical fibers.

14. The method of claim 1, wherein the plurality of optical fibers define a fractional pitch between 0.45 and 0.55.

15. The method of claim 14, wherein the fractional pitch is configured for light-capture applications, wherein the light-capture applications require large acceptance angles of great than about 5 degrees.
